(19) United States
(12) Patent Application Publication
(10) Pub. No.: US 2026/0124697 A1
(43) Pub. Date: May 7, 2026

(54) LASER APPARATUS AND ELECTRONIC DEVICE MANUFACTURING METHOD

(71) Applicant: Gigaphoton Inc., Oyama-shi (JP)

(72) Inventor: Yousuke FUJIMAKI, Oyama-shi (JP)

(73) Assignee: Gigaphoton Inc., Oyama-shi (JP)

(21) Appl. No.: 19/353,085

(22) Filed: Oct. 8, 2025

(30) Foreign Application Priority Data
Nov. 5, 2024 (JP) 2024-193648

(51) Int. Cl. B23K 26/0622

(52) U.S. Cl. CPC B23K 26/0622

(57) ABSTRACT

A laser apparatus includes an oscillator configured to output a pulse laser beam, a random phase plate disposed in an optical path of the pulse laser beam, and an optical pulse stretcher disposed in the optical path of the pulse laser beam that has passed through the random phase plate and configured to stretch a pulse time width of the pulse laser beam by transmitting part of the pulse laser beam, making the other part circulate at least once through a delay optical path, and outputting transmitted light and circulating light.

### CROSS-REFERENCE TO RELATED APPLICATIONS

The present application claims the benefit of Japanese Patent Application No. 2024-193648, filed on Nov. 5, 2024, the entire contents of which are hereby incorporated by reference.

### BACKGROUND

### 1. Technical Field

The present disclosure relates to a laser apparatus and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 pm to 400 pm. Therefore, if a projection lens is formed of a material that transmits ultraviolet light such as a KrF laser beam and an ArF laser beam, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: International Publication No. WO 2018/138819

### SUMMARY

A laser apparatus according to one aspect of the present disclosure includes an oscillator, a random phase plate, and an optical pulse stretcher. The oscillator is configured to output a pulse laser beam. The random phase plate is disposed in an optical path of the pulse laser beam. The optical pulse stretcher is disposed in the optical path of the pulse laser beam that has passed through the random phase plate and is configured to stretch a pulse time width of the pulse laser beam by transmitting part of the pulse laser beam, making the other part circulate at least once through a delay optical path, and outputting transmitted light and circulating light.

An electronic device manufacturing method according to another aspect of the present disclosure includes generating a laser beam with a laser apparatus, outputting the laser beam to an exposure apparatus, and exposing a photosensitive substrate to the laser beam within the exposure apparatus to manufacture an electronic device. The laser apparatus includes an oscillator configured to output a pulse laser beam, a random phase plate disposed in an optical path of the pulse laser beam, and an optical pulse stretcher disposed in the optical path of the pulse laser beam that has passed through the random phase plate and configured to stretch a pulse time width of the pulse laser beam by transmitting part of the pulse laser beam, making the other part circulate at least once through a delay optical path, and outputting transmitted light and circulating light.

### BRIEF DESCRIPTION OF THE DRAWINGS

Some embodiments of the present disclosure will be described below, by way of example only, with reference to the accompanying drawings.

FIG. 1 is a diagram illustrating an example of a speckle image obtained by capturing a pattern of grayscale spots.

FIG. 2 is a diagram illustrating a grayscale histogram of the speckle image illustrated in FIG. 1.

FIG. 3 schematically illustrates an exemplary configuration of a laser apparatus according to a comparative example.

FIG. 4 is an explanatory diagram illustrating a method of shifting an angle of a beam by the number of circulations of the beam within an OPS.

FIG. 5 is an explanatory diagram illustrating a method of shifting a position of the beam by the number of the circulations of the beam within the OPS.

FIG. 6 schematically illustrates an exemplary configuration of a laser apparatus according to Embodiment 1.

FIG. 7 is an explanatory diagram schematically illustrating an operation of shifting an optical path of circulating light by combining a random phase plate and the OPS.

FIG. 8 is a diagram schematically illustrating an example of a pixel pattern of the random phase plate.

FIG. 9 is a diagram illustrating a change in an electric field of the beam passing through the random phase plate.

FIG. 10 is a diagram illustrating the change in the electric field of the beam passing through the OPS.

FIG. 11 is a diagram illustrating the change in the electric field by a combination of the random phase plate and the OPS in Embodiment 1.

FIG. 12 is a diagram illustrating the change in the electric field of the beam when the OPS is disposed in front (upstream) and the random phase plate is disposed in the post stage.

FIG. 13 illustrates a cross section of the beam output from the OPS.

FIG. 14 is a diagram illustrating a method of measuring a shift amount when the beam is shifted in the OPS.

FIG. 15 schematically illustrates an exemplary configuration of an exposure apparatus.

### DESCRIPTION OF EMBODIMENTS

### Contents

1. Terms
   1.1 Speckle
   1.2 Random Phase Plate
2. Comparative Example
   2.1 Configuration
   2.2 Operation
   2.3 Problem
3 Embodiment 1
   3.1 Configuration
   3.2 Operation
   3.3 Change in Electric Field by Random Phase Plate and OPS
      3.3.1 Change in Electric Field by Random Phase Plate
      3.3.2 Change in Electric Field by Combination of Random Phase Plate and OPS
      3.3.3 Comparative Example
      3.3.4 Difference in Change in Electric Field by Difference in Positional Relation between Random Phase Plate and OPS
   3.4 Configuration of Disposing Random Phase Plate in Delay Optical Path of OPS
   3.5 Placement of Random Phase Plate when Multiple OPSes are Included
   3.6 Effect and Advantage
4. Method of Measuring Shift Amount L by OPS
5. Electronic Device Manufacturing Method
6. Processor
7. Others

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference numerals, and duplicate description thereof is omitted.

### 1. Terms

### 1.1 Speckle

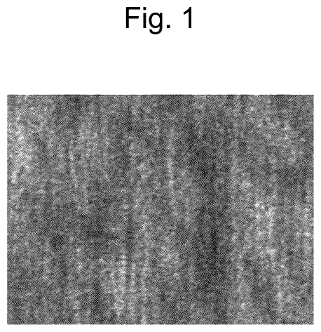

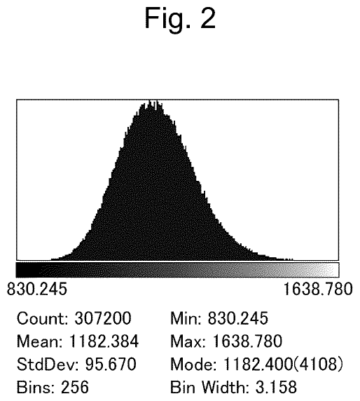

A “speckle” is a grayscale spot generated when a laser beam is scattered at a random medium. FIG. 1 is a diagram illustrating an example of a speckle image obtained by capturing a pattern of grayscale spots. FIG. 2 is a diagram illustrating a grayscale histogram of the speckle image illustrated in FIG. 1.

A speckle contrast SC is typically used as a speckle evaluation indicator. When o represents a standard deviation of intensity of a speckle image and I macron (I with a macron thereon) represents an average of the intensity of the speckle image, the speckle contrast SC can be expressed by Expression (1) below.

$$\begin{matrix}[ Expression 1 ] & \\ SC = \frac{σ}{\overline{I}} & Expression ( 1 )\end{matrix}$$

### 1.2 Random Phase Plate

A “random phase plate” is formed of two kinds of phase shift cells, namely, a pixel having a transmission phase shift amount of zero and a pixel having a transmission phase shift amount of T. The pixel having the shift amount of zero and the pixel having the shift amount of I have, for example, an area ratio of 1:1. A shape of the pixel of the random phase plate is a regular polygon such as a square or a regular hexagon, but the shape of the pixel is not limited to the regular polygon. A length of the pixel indicates a length of one side when the shape of the pixel is a regular triangle or a square, and indicates a distance between opposing sides when the shape of the pixel is a regular hexagon.

### 2. Comparative Example

### 2.1 Configuration

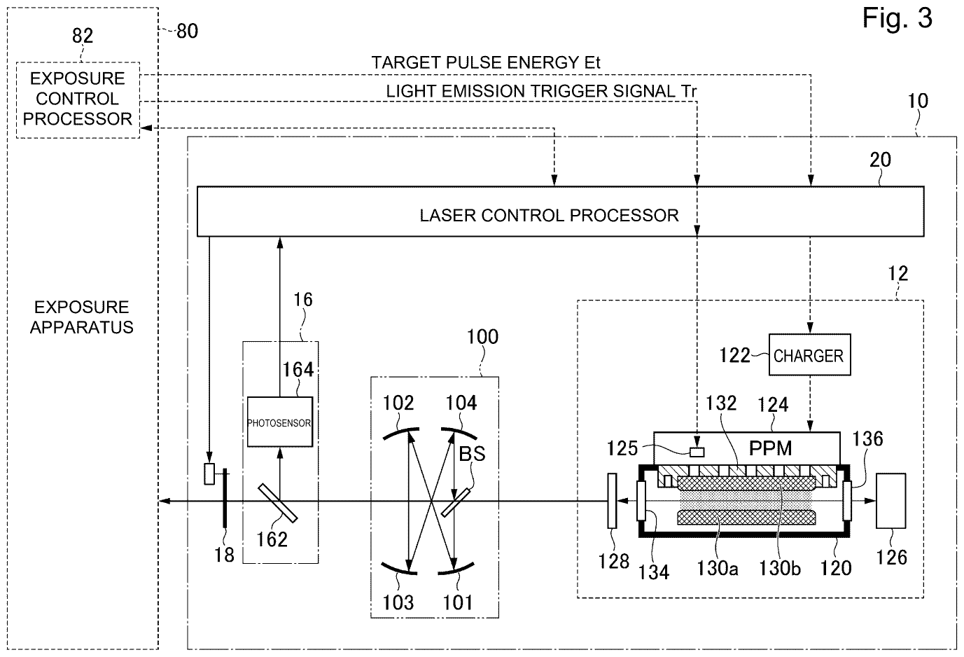

FIG. 3 schematically illustrates an exemplary configuration of a laser apparatus 10 according to the comparative example. The comparative example of the present disclosure is an example recognized by the applicant as known only by the applicant, and is not a publicly known example admitted by the applicant.

The laser apparatus 10 is an excimer laser apparatus that includes an oscillator (MO) 12, a monitor module 16, a shutter 18, and a laser control processor 20. On an optical path of a pulse laser beam output from the MO 12, an optical pulse stretcher (OPS) 100, the monitor module 16, and the shutter 18 are disposed in this order.

The MO 12 includes a chamber 120, a charger 122, a pulse power module (PPM) 124, a line narrowing device 126, and an output coupling mirror 128.

The line narrowing device 126 includes a non-illustrated prism beam expander and a non-illustrated grating. The prism beam expander and the grating are disposed in Littrow arrangement such that an incident angle and a diffracting angle are equal to each other.

The output coupling mirror 128 is, for example, a reflective mirror having a reflectance of 40% to 60%. The output coupling mirror 128 and the line narrowing device 126 constitute an optical resonator. The chamber 120 is disposed on an optical path of the optical resonator.

The chamber 120 includes a pair of electrodes 130a and 130b, an insulating member 132, a front window 134, and a rear window 136.

Laser gas of ArF, KrF, XeCl, or XeF is sealed in the chamber 120.

The electrode 130b is connected to a high-voltage output terminal of the PPM 124 through the insulating member 132. The electrode 130a is connected to the ground.

The electrode 130a and the electrode 130b are disposed at a predetermined gap interval from each other. The electrodes 130a and 130b are discharge electrodes, and a space between the electrodes 130a and 130b is a discharge space (discharge region).

The front window 134 and the rear window 136 are disposed such that a laser beam generated in the discharge space is transmitted therethrough.

The PPM 124 includes a switch 125 and a non-illustrated charging capacitor. The switch 125 is connected to a signal line through which an ON signal for the switch 125 from the laser control processor 20 is transmitted. The charger 122 is connected to the charging capacitor of the PPM 124. The charger 122 receives data of a charging voltage from the laser control processor 20 and charges the charging capacitor of the PPM 124 with a high voltage.

The OPS 100 includes a beam splitter BS and four concave mirrors 101, 102, 103, and 104. The beam splitter BS is disposed on the optical path of the pulse laser beam output from the MO 12. The beam splitter BS is coated with a film that reflects part of an incident pulse laser beam and transmits the other part. The reflectance of the beam splitter BS is preferably 40% to 70%, more preferably 60% approximately.

The concave mirrors 101 to 104 constitute a delay optical path of a pulse laser beam reflected by a first surface of the beam splitter BS. The concave mirrors 101 to 104 substantially have a same focal length f1.

The concave mirror 101 and the concave mirror 102 are disposed such that the pulse laser beam reflected by the first surface of the beam splitter BS is reflected by the concave mirror 101 and is incident on the concave mirror 102. The concave mirror 103 and the concave mirror 104 are disposed such that the pulse laser beam reflected by the concave mirror 102 is reflected by the concave mirror 103 and is incident on the concave mirror 104. The concave mirror 104 is disposed such that the pulse laser beam reflected by the concave mirror 104 is incident on a second surface of the beam splitter BS opposite to the first surface.

The concave mirror 101 and the concave mirror 102 are disposed such that the pulse laser beam reflected by the first surface of the beam splitter BS forms a first image that is an inverted image of an image on the first surface of the beam splitter BS. The concave mirror 103 and the concave mirror 104 are disposed such that the first image is returned to the beam splitter BS and formed as a second image that is a non-inverted image on the second surface of the beam splitter BS. In this case, an optical path length L1 of the delay optical path of the OPS 100 is expressed as follows: L1=8×f1. The optical path length L1 is a one-circulation delay optical path length of the delay optical path of the OPS 100.

The beam splitter BS is disposed such that a pulse laser beam not reflected but transmitted by the first surface of the beam splitter BS is incident on the monitor module 16.

The monitor module 16 is disposed on an optical path of the pulse laser beam output from the OPS 100. The monitor module 16 includes a beam splitter 162 and a photosensor 164.

The photosensor 164 is connected to the laser control processor 20, and detection data of the photosensor 164 is transmitted to the laser control processor 20. The shutter 18 is disposed on an optical path of the pulse laser beam having transmitted through the monitor module 16, and is configured to switch between outputting the pulse laser beam to an outside of the laser apparatus 10 and blocking it. The shutter 18 is connected to the laser control processor 20 through a signal line through which a shutter opening-closing signal is transmitted.

The pulse laser beam output from the laser apparatus 10 is input to an exposure apparatus 80.

The laser control processor 20 is connected to an exposure control processor 82. Signal lines between the laser control processor 20 and the exposure control processor 82 include a signal line for a light emission trigger signal Tr, a signal line for data of target pulse energy Et, and a signal line for transferring any other signals.

Note that a non-illustrated amplifier including a laser chamber may be disposed between the MO 12 and the OPS 100.

The MO 12 may include a solid-state laser such as a YAG laser instead of an excimer laser. In that case, the MO 12 may include a semiconductor optical amplifier (SOA) that cuts out a pulse beam from continuous light.

### 2.2 Operation

When having received the target pulse energy Et and an oscillation preparation signal from the exposure control processor 82, the laser control processor 20 outputs a signal for closing the shutter 18 and closes an exit port of the laser apparatus 10.

When the laser control processor 20 turns on the switch 125 of the PPM 124 in synchronization with the light emission trigger signal Tr at a predetermined repetition frequency, a high voltage is applied between the electrodes 130a and 130b.

When insulation breakdown occurs between the electrodes 130a and 130b, discharge occurs between the two electrodes and excimer laser gas is excited. As a result, laser oscillation occurs at the optical resonator constituted by the line narrowing device 126 and the output coupling mirror 128, and a line-narrowed pulse laser beam is output from the output coupling mirror 128.

The pulse laser beam output from the output coupling mirror 128 is stretched to a predetermined pulse time width by being caused to pass through the delay optical path for a plurality of times by the OPS 100.

Part of the pulse laser beam having passed through the OPS 100 is reflected by the beam splitter 162 and is incident on the photosensor 164. The photosensor 164 measures pulse energy E of the incident pulse laser beam. Data indicating a result of the measurement is transmitted from the photosensor 164 to the laser control processor 20.

The laser control processor 20 sets the charging voltage of the charger 122 such that a difference ΔE between the target pulse energy Et and the measured pulse energy E approaches zero.

When the difference ΔE falls into an allowable range, the laser control processor 20 transmits an oscillation preparation completion signal to the exposure control processor 82 and opens the shutter 18. The laser control processor 20 turns on the switch 125 of the PPM 124 in synchronization with the light emission trigger signal Tr from the exposure control processor 82. As a result, the pulse laser beam is output from the MO 12 and is pulse-stretched by the OPS 100, and the pulse laser beam close to the target pulse energy Et is output from the laser apparatus 10.

The pulse laser beam output from the laser apparatus 10 is incident on the exposure apparatus 80, and resist of a non-illustrated semiconductor wafer or the like is irradiated with the pulse laser beam.

### 2.3 Problem

In order to reduce the speckle contrast, it is necessary to reduce temporal overlap and spatial overlap of pulses. In order to reduce the spatial overlap, a method is known to shift an angle or a position of the pulse laser beam by the number of circulations through the delay optical path of the OPS 100. Hereinafter, the pulse laser beam may simply be referred to as a “beam.”

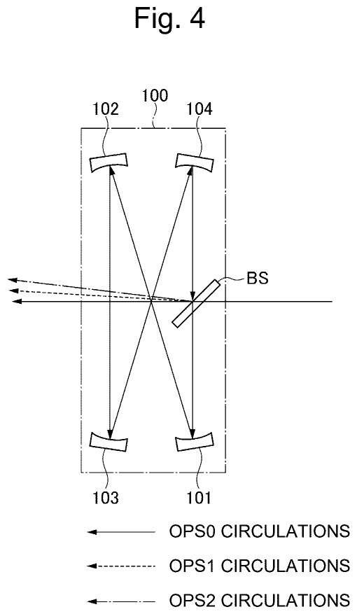

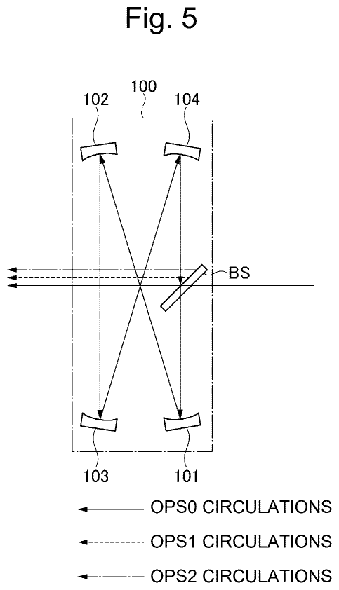

FIG. 4 is an explanatory diagram illustrating a method of shifting the angle of the beam by the number of the circulations of the beam within the OPS 100. FIG. 5 is an explanatory diagram illustrating a method of shifting the position of the beam by the number of the circulations of the beam within the OPS 100. In FIGS. 4 and 5, the beam output from the OPS 100 after zero circulations in the OPS 100 is indicated with a solid line, the beam output after one circulation is indicated with a dashed line, and the beam output after two circulations is indicated with a dotted line. By adjusting arrangement of the concave mirrors 101 to 104, the angle of the beam can be changed by the number of the circulations, as illustrated in FIG. 4.

In addition, by adjusting the arrangement of the concave mirrors 101 to 104, the position of the beam can be changed by the number of the circulations, as illustrated in FIG. 5. Note that in FIG. 4, FIG. 5, and subsequent figures, for convenience of illustration, depiction of the light after three and more circulations is omitted.

In order to reduce the speckle contrast, it is necessary to increase a shift amount of the angle or the position, but in that case, energy loss due to beam vignetting occurs.

For example, in order to reduce the speckle contrast, in the case of shifting the beam angle (FIG. 4), it is necessary to shift the angle by about a half of original beam divergence, and in the case of shifting the beam position (FIG. 5), it is necessary to shift the position by about a half of a beam size.

There is a demand for provision of a laser apparatus that reduces speckle contrast, that is, reduces beam coherence, and suppresses energy loss.

### 3 Embodiment 1

### 3.1 Configuration

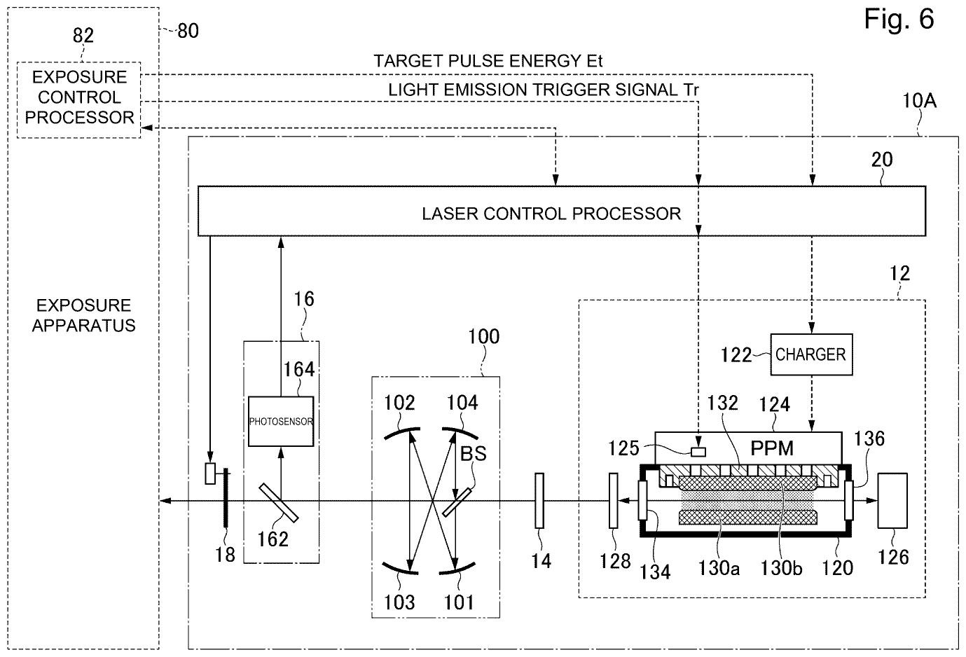

FIG. 6 schematically illustrates an exemplary configuration of a laser apparatus 10A according to Embodiment 1. Description will be made on any difference of the laser apparatus 10A illustrated in FIG. 6 from the configuration illustrated in FIG. 3. The laser apparatus 10A includes a random phase plate 14 between the OPS 100 and the MO 12. Hereafter, the random phase plate will also be referred to as an “RPP.”

The position where the random phase plate 14 is added can be anywhere between the OPS 100 and the MO 12. For example, if there are other optical elements or the like between the OPS 100 and the MO 12, the position where the random phase plate 14 is displaced may be upstream or downstream of those optical elements.

The concave mirrors 101, 102, 103, and 104 are positioned such that an optical path at the time of output is displaced according to the number of the circulations in the OPS 100. The positions of the concave mirrors 101, 102, 103, and 104 include a case where the optical path at the time of output is displaced according to the number of the circulations, even if they are not intentionally positioned that way. The concave mirrors 101, 102, 103, and 104 are an example of “a plurality of mirrors” in the present disclosure.

The other configuration is the same as the configuration of the laser apparatus 10 illustrated in FIG. 3.

### 3.2 Operation

In the laser apparatus 10A, the random phase plate 14 is disposed in front (upstream) of the OPS 100, and an optical path of circulating light is shifted by the OPS 100 according to the number of the circulations.

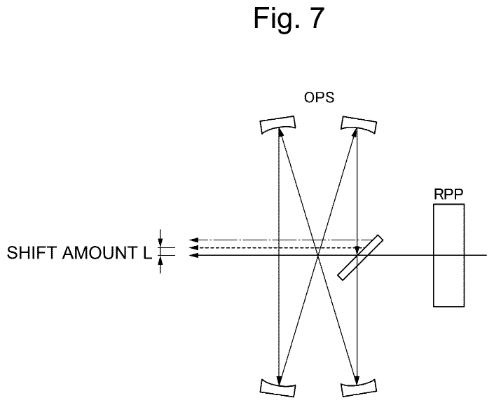

FIG. 7 is an explanatory diagram schematically illustrating an operation of shifting the optical path of the circulating light by combining the random phase plate 14 and the OPS 100.

The pulse laser beam output from the MO 12 passes through the random phase plate 14. The beam after passing through the random phase plate 14 enters the OPS 100. The beam is split by the beam splitter BS in the OPS 100, and one beam is transmitted through the beam splitter BS and exits the OPS 100. Part of the other beam circulates within the OPS 100 and is then reflected by the beam splitter BS to exit the OPS 100, while the remaining part is transmitted through the beam splitter BS to circulate within the OPS 100 again. Thereafter, the circulating light repeats the operation.

For the beam of the circulating light that has circulated through the delay optical path of the OPS 100 at least once, the optical path for exiting the OPS 100 is displaced compared to the beam of transmitted light transmitted through the beam splitter BS with zero circulations. It is preferable that the displacement of the optical paths of the transmitted light and the circulating light is parallel translation. A shift amount L of the optical path at the time of the parallel translation is preferably greater than or equal to a pixel size of the random phase plate 14.

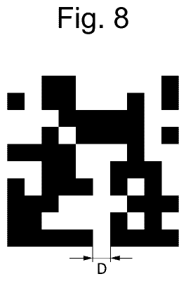

FIG. 8 is a diagram schematically illustrating an example of a pixel pattern of the random phase plate 14. FIG. 8 illustrates an example of the random phase plate 14 where square pixels are two-dimensionally arrayed. A pixel size D of the random phase plate 14 may be defined as a length of one side of the square pixel. It is desirable to set the pixel size D to satisfy Expression (2) below in order to suppress increase in the beam divergence and to further reduce the beam vignetting downstream of the random phase plate 14.

$$0.5 a \leq D \qquad Expression ( 2 )$$

In Expression (2), a size of a coherence area is denoted by a. For a typical excimer laser apparatus, a is between 0.1 mm and 0.5 mm.

The pixel size D is greater than or equal to 0.5a, and for the excimer laser apparatus, the pixel size D is preferably greater than or equal to 0.05 mm. Note that it is even more desirable that the pixel size D satisfies 0.5a<D.

It is preferable when the shift amount L at the time of the parallel translation of the optical path of the circulating light output from the OPS 100 is greater than or equal to the pixel size D of the random phase plate 14 as illustrated in FIG. 7, since speckles can be reduced more efficiently.

Further, it is desirable when the shift amount L is less than twice the pixel size D, since the beam size does not become too large, and the loss due to the beam vignetting downstream is reduced. That is, it is desirable for the shift amount L to satisfy Expression (3) below.

$$D \leq L \leq 2 D \qquad Expression ( 3 )$$

The shift amount L is an example of a “displacement amount” in the present disclosure. D≤L is an example of “a displacement amount is greater than or equal to a pixel size” in the present disclosure. L≤2D is an example of “the displacement amount is less than or equal to twice the pixel size” in the present disclosure.

### 3.3 Change in Electric Field by Random Phase Plate and OPS

### 3.3.1 Change in Electric Field by Random Phase Plate

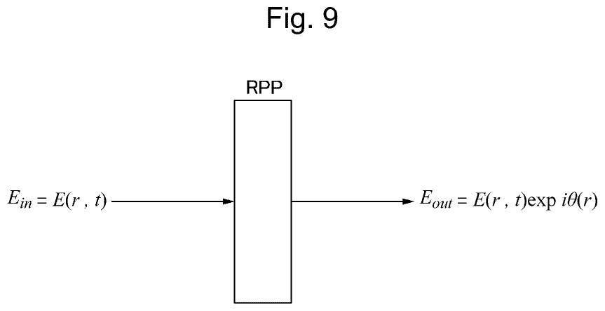

FIG. 9 is a diagram illustrating a change in an electric field of the beam passing through the random phase plate 14.

E(r, t) is a complex function representing the electric field. A position on a beam is represented by r that is (x, y), and time is represented by t. θ(r) is a function representing a phase distribution of the random phase plate 14, with 0 or π being randomly distributed.

When the beam passes through the random phase plate 14, a phase part of the electric field changes, and the electric field of the beam changes from Eᵢₙ illustrated on a left side of FIG. 9 to Eₒᵤₜ illustrated on a right side.

### 3.3.2 Change in Electric Field by OPS

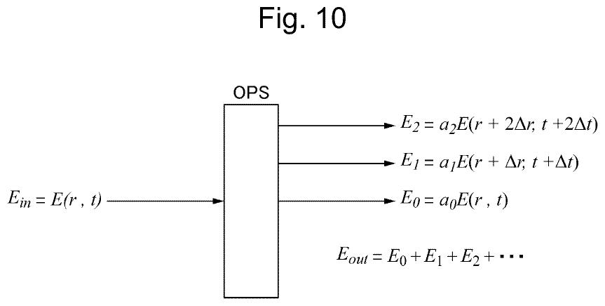

FIG. 10 is a diagram illustrating the change in the electric field of the beam passing through the OPS 100. E₀, E₁, and E₂ illustrated on the right side of FIG. 10 represent the electric fields of the light after zero circulations, the light after one circulation, and the light after two circulations, respectively.

As illustrated in FIG. 10, when the electric field Eᵢₙ enters the OPS 100, the electric field Eₒᵤₜ after passing through the OPS 100 becomes a superposition of the electric fields of each circulating light, as illustrated on the right side of FIG. 10.

In FIG. 10, it is assumed that every time the beam circulates in the OPS 100, the optical path of the beam is shifted by Δr and the time is delayed by Δt.

Coefficients corresponding to an intensity change of the beam for each OPS circulation are represented by a₀, a₁, and a₂, and are determined by the reflectance of the beam splitter BS within the OPS 100 and propagation loss within the OPS 100. Since the OPS 100 is a relay optical system, it is assumed that the function of the electric field does not change except for the shift in the position r on the beam and the time t, even if the beam circulates.

### 3.3.2 Change in Electric Field by Combination of Random Phase Plate and OPS

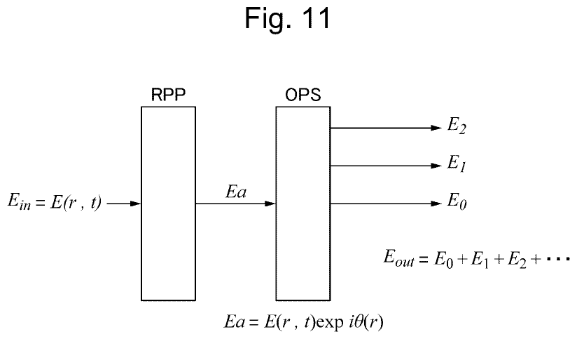

FIG. 11 is a diagram illustrating the change in the electric field by a combination of the random phase plate 14 and the OPS 100 in Embodiment 1.

In FIG. 11, Eᵢₙ represents the electric field that enters the random phase plate 14, and Eₐ represents the electric field after the beam passes through the random phase plate 14.

If the beam passes through the OPS 100 after passing through the random phase plate 14, the electric field Eₒᵤₜ of the beam output from the OPS 100 is as follows.

$${E}_{out} = {E}_{0} + {E}_{1} + {E}_{2} + … = {a}_{0} E ( r , t ) exp i θ ( r ) + {a}_{1} E ( r + Δ r , t + Δ t ) exp i θ ( r + Δ r ) + {a}_{2} E ( r + 2 Δ r , t + 2 Δ t ) exp i θ ( r + 2 Δ r ) + …$$

In the equation, the position r of the phase part is displaced by Δr for each circulation. This is equivalent to the position of the random phase plate 14 being changed for each OPS circulation.

### 3.3.3 Comparative Example

For comparison, the change in the electric field in a configuration where a positional relation between the random phase plate 14 and the OPS 100 is reversed will be described.

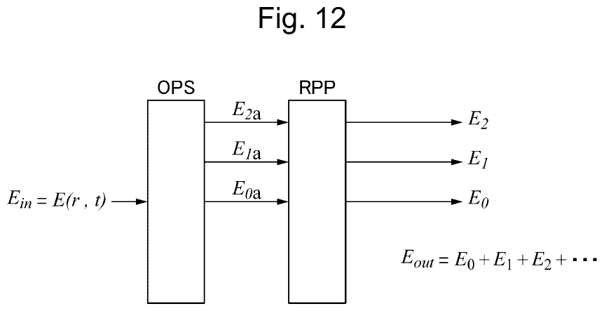

FIG. 12 is a diagram illustrating the change in the electric field of the beam when the OPS 100 is disposed in front (upstream) and the random phase plate 14 is disposed in the post stage.

In FIG. 12, E₀ₐ, E₁ₐ, and E₂ₐ represent the electric fields of each circulating light after passing through the OPS 100. When the beam passes through the random phase plate 14 after passing through the OPS 100, the electric field Eₒᵤₜ of the beam output from the random phase plate 14 is as follows.

$${E}_{out} = {E}_{0} + {E}_{1} + {E}_{2} + … = {a}_{0} E ( r , t ) exp i θ ( r ) + {a}_{1} E ( r + Δ r , t + Δ t ) exp i θ ( r ) + {a}_{2} E ( \text{r} \text{+ 2Δ} r , t + 2 Δ t ) exp i θ ( r ) + …$$

In the equation, since the random phase plate 14 is stationary, the position r of the phase part is fixed regardless of the circulations.

### 3.3.4 Difference in Change in Electric Field by Difference in Positional Relation Between Random Phase Plate and OPS

As is clear when the configuration of Embodiment 1 described in FIG. 11 is compared with the comparative example described in FIG. 12, the position r of the phase part of the electric field Eₒᵤₜ that is ultimately output is different between the two.

When the random phase plate 14 is in front of the OPS 100 (FIG. 11), the position r of the phase part changes for each OPS circulation as r→r+Δr→r+2Δr→ . . . . This has the same effect as the position of the random phase plate 14 being changed for each OPS circulation.

That is, when the OPS 100 disposed behind the random phase plate 14 is used to shift the optical path of the beam as in the configuration of Embodiment 1 (FIG. 11), even if the random phase plate 14 is stationary, the same effect as if the random phase plate 14 were moved is obtained.

Therefore, compared to the case where the beam is shifted by the OPS 100 alone (FIG. 5), the configuration of Embodiment 1 (FIG. 11) results in a greater reduction effect in the speckle contrast due to a more significant decrease in coherence.

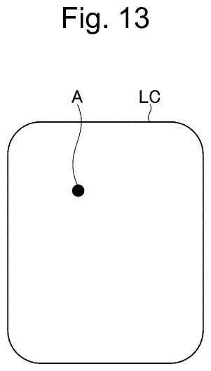

FIG. 13 illustrates a cross section LC of the beam output from the OPS 100. The beam output from the OPS 100 includes the transmitted light (the light after zero circulations) and the circulating light. In the case of the laser apparatus 10A according to Embodiment 1, the beam at the position of a point A illustrated in FIG. 13 passes through different positions of the random phase plate 14 according to the number of the circulations, allowing for efficient reduction in the coherence as described above.

On the other hand, in the case of the comparative example illustrated in FIG. 12, the beam at the position of the point A passes through the same position of the random phase plate 14 in the post stage regardless of the number of the circulations, resulting in a smaller reduction effect of the coherence as compared to FIG. 11.

In order to reduce the coherence of the laser beam, it is necessary to integrate beams that have no or little correlation. Shifting the position of the random phase plate 14 by the pixel size D results in a property where the correlation becomes virtually nonexistent. Note that, in reality, due to the finite number of pixels in the random phase plate 14, the correlation does not become completely zero, however, it can be practically considered close to zero.

Therefore, the shift amount of the random phase plate 14 necessary to reduce the coherence is equal to the pixel size D of the random phase plate 14.

### 3.4 Configuration of Disposing Random Phase Plate in Delay Optical Path of OPS

Another method to reduce the coherence is to dispose the random phase plate 14 in the optical path of the OPS 100, however, in that case, the beam divergence increases as the beam passes through the random phase plate 14 every time it circulates, making it difficult to suppress the beam vignetting. Therefore, it is preferable to dispose the random phase plate 14 in the optical path between the oscillator and the OPS 100 rather than disposing it in the optical path of the OPS 100.

### 3.5 Placement of Random Phase Plate when Multiple OPSes are Included

While the laser apparatus 10A includes one OPS 100 in the post stage (downstream) of the random phase plate 14, it is also possible to include a plurality of OPSes in the post stage of the random phase plate 14. For example, the laser apparatus 10A may be configured to include not only the OPS 100 as a first OPS but also a non-illustrated second OPS downstream of the OPS 100. In addition, the laser apparatus 10A may be configured to include a non-illustrated third OPS further downstream of the second OPS.

In the case of a laser apparatus including the OPSes, it is desirable to dispose the random phase plate 14 in the optical path between the first OPS and the oscillator. By doing so, a similar reduction in the coherence can be expected in the OPS in the post stage as well.

### 3.6 Effect and Advantage

According to the laser apparatus 10A, by suppressing the energy loss due to the beam vignetting and efficiently reducing the beam coherence, the speckle contrast can be efficiently reduced.

### 4. Method of Measuring Shift Amount L of Optical Path by OPS

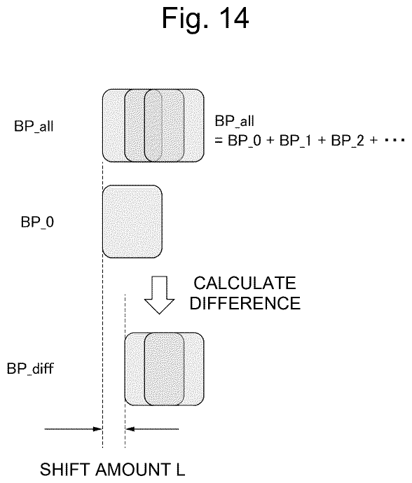

FIG. 14 is a diagram illustrating a method of measuring the shift amount L of the optical path for each circulation when the beam is shifted in the OPS 100. The shift amount L can be measured by following procedures.
[Procedure 1] First, as illustrated in an upper part of FIG. 14, a beam profile BP_all of the beam output from the OPS 100 is measured. The beam profile BP_all is obtained by integrating beam profiles of the circulating light after zero circulations, one circulation, and two circulations, . . . . Beam profiles BP_all and BP_0 are measured immediately after the beam splitter BS using a beam profiler or the like.
[Procedure 2] Next, the beam profile BP_0 is measured in a state where a circulating optical path is blocked in the OPS 100. By blocking the circulating optical path, the beam profile BP_0 of only the light after zero circulations is obtained (see a middle part of FIG. 14).
[Procedure 3] A difference BP_diff between the beam profile BP_all and the beam profile BP_0 is calculated (see a lower part of FIG. 14).
[Procedure 4] By comparing the beam profile BP_0 with the difference BP_diff, the shift amount L of the beam profile is obtained.

### 5. Electronic Device Manufacturing Method

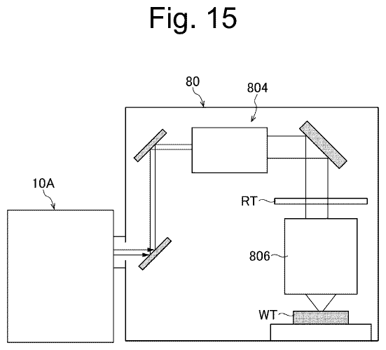

FIG. 15 schematically illustrates an exemplary configuration of the exposure apparatus 80. In FIG. 15, the exposure apparatus 80 includes an illumination optical system 804 and a projection optical system 806. The illumination optical system 804 illuminates a reticle pattern of a non-illustrated reticle disposed on a reticle stage RT with the laser beam incident from the laser apparatus 10A. The laser beam having transmitted through the reticle is subjected to reduced projection through the projection optical system 806 and is imaged on a non-illustrated workpiece disposed on a workpiece table WT. The workpiece is a photosensitive substrate such as a semiconductor wafer on which photoresist is applied. The exposure apparatus 80 translates the reticle stage RT and the workpiece table WT in synchronization so that the workpiece is exposed to the laser beam on which the reticle pattern is reflected. The reticle pattern is transferred to the semiconductor wafer through an exposure process as described above, and then a plurality of processes are performed to manufacture a semiconductor device.

### 6. Processor

The processors such as the laser control processor 20 and the exposure control processor 82 may be physically configured as hardware to execute various processes included in the present disclosure. For example, the processor may be a computer including a memory that stores a control program defining the various processes and a processing device that executes the control program. The control program may be stored in one memory, or may be stored separately in a plurality of memories at physically separate locations, and the various processes may be defined by a combination of the control programs stored in the memories. The processing device may be a general-purpose processing device such as a CPU or a special-purpose processing device such as a GPU.

Alternatively, the processor may be programmed as software to execute various processes included in the present disclosure. For example, the processor may be implemented in a dedicated device such as an ASIC or a programmable device such as an FPGA that executes the various processes.

The various processes included in the present disclosure may be executed by one computer, one dedicated device, or one programmable device, or may be executed by cooperation of a plurality of computers, a plurality of dedicated devices, or a plurality of programmable devices at physically separated locations. The various processes may be executed by a combination including at least any two of one or more computers, one or more dedicated devices, and one or more programmable devices.

In order for the laser control processor 20 and the exposure control processor 82 illustrated in FIG. 3 and FIG. 6 to execute processing described in the embodiments, calculation processing may be performed by the processor and the memory after performing digitization by an analog electric signal processing circuit or an AD converter.

Alternatively, the processing may be divided by processing functions different from the above and separately performed by the processing devices, or the processing may be aggregated and performed by one processing device. For example, the laser control processor 20 and the exposure control processor 82 may be aggregated into one processing device to perform the processing. These choices are appropriately selected according to a speed and accuracy of the processing, among other factors.

### 7 Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless otherwise stated. For example, terms such as “comprise”, “include”, “have”, and “contain” should not be interpreted to be exclusive of other components. Furthermore, indefinite articles “a/an” should be interpreted to mean “at least one” or “one or more.” Further, “at least one of A, B, and C” should be interpreted to mean any of A, B, C, A+B, A+C, B+C, and A+B+C. Further, it should be also interpreted to include combinations of any thereof and any other than A, B, and C.

What is claimed is:

1. A laser apparatus comprising:
an oscillator configured to output a pulse laser beam;
a random phase plate disposed in an optical path of the pulse laser beam; and
an optical pulse stretcher disposed in the optical path of the pulse laser beam that has passed through the random phase plate and configured to stretch a pulse time width of the pulse laser beam by transmitting part of the pulse laser beam, making the other part circulate at least once through a delay optical path, and outputting transmitted light and circulating light.

2. The laser apparatus according to claim 1, wherein
optical paths of the transmitted light and the circulating light output from the optical pulse stretcher are displaced from each other.

3. The laser apparatus according to claim 2, wherein
a displacement of the optical paths of the transmitted light and the circulating light is parallel translation.

4. The laser apparatus according to claim 2, wherein
the optical pulse stretcher includes
a plurality of mirrors forming the delay optical path, and
the mirrors are disposed so as to displace the delay optical path and an optical path when each circulating light is output in a case where the number of circulations is two or more.

5. The laser apparatus according to claim 2, wherein
a displacement amount of the optical path generated every time the circulating light circulates once through the delay optical path is greater than or equal to a pixel size of the random phase plate.

6. The laser apparatus according to claim 5, wherein
the displacement amount is less than or equal to twice the pixel size.

7. The laser apparatus according to claim 1, wherein,
when a size of a coherence area of the pulse laser beam output from the oscillator is denoted by a,
a pixel size of the random phase plate is greater than or equal to 0.5a.

8. The laser apparatus according to claim 1, wherein
a pixel size of the random phase plate is greater than or equal to 0.05 mm.

9. The laser apparatus according to claim 1, wherein
the optical pulse stretcher includes
a beam splitter and a concave mirror.

10. The laser apparatus according to claim 9, wherein
the delay optical path is formed of a plurality of concave mirrors.

11. The laser apparatus according to claim 1, wherein
the oscillator includes an excimer laser apparatus.

12. The laser apparatus according to claim 1, comprising
a second optical pulse stretcher downstream of a first optical pulse stretcher which is the optical pulse stretcher.

13. The laser apparatus according to claim 12, comprising
a third optical pulse stretcher downstream of the second optical pulse stretcher.

14. The laser apparatus according to claim 1, wherein
The random phase plate is stationary.

15. An electronic device manufacturing method comprising:
generating a laser beam with a laser apparatus, the laser apparatus including
an oscillator configured to output a pulse laser beam,
a random phase plate disposed in an optical path of the pulse laser beam, and
an optical pulse stretcher disposed in the optical path of the pulse laser beam that has passed through the random phase plate and configured to stretch a pulse time width of the pulse laser beam by transmitting part of the pulse laser beam, making the other part circulate at least once through a delay optical path, and outputting transmitted light and circulating light;
outputting the laser beam to an exposure apparatus; and
exposing a photosensitive substrate to the laser beam within the exposure apparatus to manufacture an electronic device.
